(19) United States
(12) Patent Application Publication
(10) Pub. No.: US 2016/0024944 A1
(43) Pub. Date: Jan. 28, 2016

(54) TRANSIENT LIQUID PAHSE BONDED TURBINE ROTOR ASSEMBLY

(71) Applicant: UNITED TECHNOLOGIES CORPORATION, Hartford, CT (US)

(72) Inventors: Gabriel L. Suciu, Glastonbury, CT (US); Ioannis Alvanos, West Springfield, MA (US); Grant O. Cook, III, Spring, TX (US); Mark F. Zelesky, Bolton, CT (US); Dilip M. Shah, Glastonbury, CT (US)

(21) Appl. No.: 14/775,730

(22) PCT Filed: Feb. 26, 2014
(86) PCT No.: PCT/US14/18630

§ 371 Date: Sep. 14, 2015

Related U.S. Application Data
(60) Provisional application No. 61/781,433, filed on Mar. 14, 2013.

(51) Int. Cl. F01D 5/30; F02C 3/04; F01D 5/18

(52) U.S. Cl. CPC F01D 5/30; F01D 5/18; F02C 3/04

(57) ABSTRACT

A rotor assembly for a turbine engine includes a rotor disk constructed of a first material. Multiple rotor blades constructed of a second material are connected to the rotor disk via a diffusion material.

### TECHNICAL FIELD

The present disclosure relates generally to rotor assemblies for a turbine engine and more specifically to a rotor assembly utilizing a transient liquid phase bonding process.

### BACKGROUND OF THE INVENTION

Turbine engines, such as those utilized in commercial aircraft, include a compressor section, a turbine section, and a combustor section that operate cooperatively to generate thrust. Included within at least the turbine section is a series of rotor assemblies. The rotor assemblies include a rotating disk and multiple individual blades or blade assemblies connected to a radially outward edge of the rotating disk.

In existing rotor assemblies, the rotor blades or rotor blade assemblies are connected to the rotor disk using a geometrically interfacing design typically referred to as a fir tree connection. The geometric interfacing of the fir tree connection holds the blade or blade assembly in place radially. A cover plate is then fit on at least one axial side of the rotor assembly and provides an axially loading thereby maintaining the rotor blade or blade assembly in position axially relative to the rotor disk.

### SUMMARY OF THE INVENTION

A turbine engine according to an exemplary embodiment of this disclosure, among other possible things includes a compressor section, a combustor in fluid communication with the compressor section, a turbine section in fluid communication with the combustor, a gas path defined by the compressor section, the combustor and the turbine section, the gas path includes at least one rotor assembly, the rotor assembly includes, a rotor disk constructed of a first material, a plurality of rotor blades constructed of a second material, and a transient liquid phase bond connecting a bond surface of the rotor disk and a bond surface of each of the rotor blades.

In a further embodiment of the foregoing turbine engine, the transient liquid phase bond is a partial transient liquid phase bond.

In a further embodiment of the foregoing turbine engine, the transient liquid phase bond is a combined transient liquid phase bond and partial transient liquid phase bond.

In a further embodiment of the foregoing turbine engine, the transient liquid phase bond is a diffusion layer formed of material diffused from a thin foil interlayer material.

A further embodiment of the foregoing turbine engine, includes at least one cover plate connected to a cover plate mounting feature of the rotor disk, the cover plate is spaced from a root portion of the rotor blade.

A further embodiment of the foregoing turbine engine, includes a compressor blade cooling flow passage disposed entirely within the rotor blade.

A further embodiment of the foregoing turbine engine, includes a blade cooling flow passage having a blade cooling flow passage inlet disposed on an inner diameter surface of said rotor blade, and defined entirely by the rotor blade.

In a further embodiment of the foregoing turbine engine, each of the rotor blades is constructed of a high temperature, low ductility first material, and the rotor disk is constructed of a second material having, as compared to the first material lower temperature and higher ductility.

In a further embodiment of the foregoing turbine engine, each of the rotor blades is sealed on an axially outer end to at least one corresponding stator.

A rotor assembly for a turbine engine according to an exemplary embodiment of this disclosure, among other possible things includes a rotor disk constructed of a first material, a plurality of rotor blades constructed of a second material, and a diffusion material diffused into a diffusion region of the rotor disk and a diffusion region of each of the rotor blades, thereby bonding each of the rotor blades to the rotor disk.

In a further embodiment of the foregoing rotor assembly, the transient liquid phase bond is a partial transient liquid phase bond.

In a further embodiment of the foregoing rotor assembly, the transient liquid phase bond is a combined transient liquid phase bond and partial transient liquid phase bond.

In a further embodiment of the foregoing rotor assembly, the transient liquid phase bond is a diffusion layer formed of material diffused from a thin foil interlayer material.

A further embodiment of the foregoing rotor assembly, includes at least one cover plate connected to a cover plate mounting feature of the rotor disk, the cover plate is spaced from a diffusion region of the rotor blade.

A further embodiment of the foregoing rotor assembly, includes a compressor blade cooling flow passage disposed entirely within the rotor blade.

A further embodiment of the foregoing rotor assembly, includes a blade cooling flow passage having including a blade cooling flow passage inlet disposed on an inner diameter surface of the rotor blade, and defined entirely by the rotor blade.

In a further embodiment of the foregoing rotor assembly, each of the rotor blades is constructed of a gamma ti material, and the rotor disk is constructed of a nickel alloy.

In a further embodiment of the foregoing rotor assembly, the rotor assembly is characterized by a lack of cover plates.

A method for assembling a rotor assembly for a turbine engine according to an exemplary embodiment of this disclosure, among other possible steps includes disposing an interlayer material between a rotor blade bond surface and a rotor disk bond surface, heating the interlayer material such that the interlayer material diffuses into each of the rotor blade bond surface and the rotor disk bond surface, thereby creating an interlayer bond connecting the rotor blade to the rotor disk.

A further embodiment of the foregoing rotor assembly, includes repeating the steps of disposing an interlayer material between a rotor blade bond surface and a rotor disk bond surface and heating the interlayer material such that the interlayer material diffuses into each of the rotor blade bond surface and the rotor disk bond surface, thereby creating an interlayer bond connecting the rotor blade to the rotor disk for each rotor blade connected to the rotor disk.

A further embodiment of the foregoing method includes repeating the steps of disposing an interlayer material between a rotor blade bond surface and a rotor disk bond surface and heating the interlayer material such that the interlayer material diffuses into each of the rotor blade bond surface and the rotor disk bond surface, thereby creating an interlayer bond connecting the rotor blade to the rotor disk for each rotor blade connected to the rotor disk.

In a further embodiment of the foregoing method the step of disposing an interlayer material between a rotor blade bond surface and a rotor disk bond surface comprises disposing an interlayer material having a single material composition between the rotor blade bond surface and a rotor disk bond surface.

In a further embodiment of the foregoing method, the step of disposing an interlayer material between a rotor blade bond surface and a rotor disk bond surface comprises disposing an interlayer material at least having layers of a low-melting point interlayer material on at least two sides of a refractory material layer between the rotor blade bond surface and a rotor disk bond surface.

In a further embodiment of the foregoing method, the step of disposing an interlayer material between a rotor blade bond surface and a rotor disk bond surface includes disposing an interlayer material including two distinct material layers between the rotor blade bond surface and a rotor disk bond surface.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

These and other features of the present invention can be best understood from the following specification and drawings, the following of which is a brief description.

### BRIEF DESCRIPTION OF THE DRAWINGS

FIG. 1 schematically illustrates an exemplary gas turbine engine 20.

FIG. 2 schematically illustrates an exemplary isometric view of a rotor disk and blade attachment.

FIG. 3 schematically illustrates a partial fore view of a rotor blade and rotor disk connection.

FIG. 4 schematically illustrates a partial view of a rotor blade and rotor disk connection.

### DETAILED DESCRIPTION OF AN EMBODIMENT

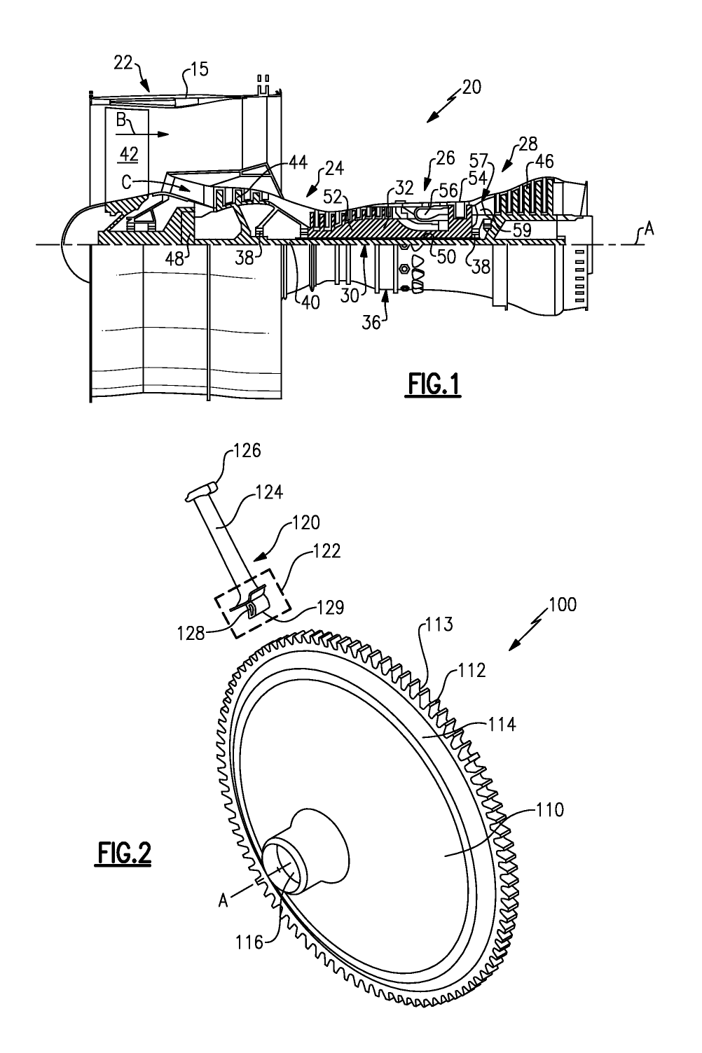

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 50 may be varied. For example, gear system 50 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (“TSFC”)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

FIG. 2 schematically illustrates an isometric view of an example rotor disk 110 and a blade assembly 120 for a rotor assembly 100. In a completed rotor assembly 100 multiple blade assemblies 120 are attached as described below to the single-rotor disk 110. The rotor disk 110 includes multiple blade mounting features 112. Each of the blade mounting features 112 in the illustrated example is a planar surface that is capable of interfacing to a corresponding planar surface 129 on the rotor blade assembly 120. An open area 113 is located between each of the multiple blade mounting features 112.

The rotor disk 110 also includes a cover plate mounting feature 114 for mounting a rotor disk cover plate (not pictured) to a fully assembled rotor assembly 100. The rotor disk 110 also includes an axial shaft hole 116 aligned with the engine centerline axis A. In a completed turbine engine assembly, the shaft hole 116 is disposed about the outer shaft 50 (illustrated in FIG. 1) of a turbine engine 20, such that the rotor assembly 100 rotates along with the outer shaft 50.

Each of the rotor blade assemblies 120 includes a mounting portion 122, a blade portion 124 and a seal portion 126. The mounting portion 122 includes the planar surface 129 for connecting the rotor blade assembly 120 to the rotor disk 110 and a blade cooling flow passage opening 128 that allows a cooling fluid flow (such as air flow) to flow into a cooling passage within the rotor blade assembly 120. On a radially outer end of the rotor blade assembly 120 is a sealing portion 126. The sealing portion 126 in one aspect possesses a shroud with knife edge. The knife edge meshes with an abradable seal to minimize airflow leakage at the blade tip. In another aspect, the sealing portion 126 may comprise an outer shroud that interfaces in one or more locations with a circumferential seal to minimize airflow leakage at the blade tip.

In one aspect, a transient liquid phase bonding connects the rotor blade assembly 120 to the rotor disk 110. In another aspect, multiple rotor blade assemblies 120 are affixed to the rotor disk 110 using a transient liquid phase bonding. Transient liquid phase bonding is a bond that joins materials via the use of an interlayer material.

To form the transient liquid phase bond between two materials, the following process is used. Initially an interlayer material is disposed between the mating surfaces of the two parts to be bonded. In the illustrated example, the planar surface 129 of the rotor blade assembly 120 and the mating surface on the rotor disk 110 are the mating surfaces. Heat is then applied to the rotor assembly 120 and the rotor disk 110 raising the rotor assembly 120 and the rotor disk 110 to a specified bonding temperature that produces a liquid in the bond region. In one aspect, the liquid is formed substantially of melted interface material. In one aspect, the heat is applied to only a localized region of the rotor assembly 120 and the rotor disk 110 near the interface location where the interlayer material is placed. In one aspect, the interlayer material has two distinct layers, each of which forms a eutectic liquid.

Next, the parts are held at the specified bonding temperature until the liquid isothermally solidifies due to diffusion into the respective parts. In the illustrated example, the interlayer material diffuses into the materials of the rotor blade assembly 120 and the rotor disk 110 to form the bond. In another aspect, the resulting transient liquid phase bond is then homogenized via a heat treating process.

The above described process forms a transient liquid phase bond connecting the rotor disk 110 to the rotor blade assembly 120 with the bond having a higher melting point than the temperature required to form the bond. In other aspects, during the heating and isothermal solidification process steps, the parts are urged together at the mating surface(s). In another aspect, one or more the mating surfaces are prepared with a surface treatment to encourage diffusion such as partial oxidation or stripping of the mating surface.

The interlayer material utilized for the bonding process can be a thin foil (such as a rolled sheet of foil), an amorphous foil (such as a melt-spun foil), a fine powder, a powder compact, a brazing paste, a physical vapor deposition process, a chemical vapor deposition process, electroplating, or evaporating an element of a substrate material to create a glazed surface. Heating of the interlayer material to cause diffusion can be done using any appropriate heating method including radiation heating, conduction heating, radio-frequency induction heating, resistance heating, laser heating, and infrared heating.

The transient liquid phase bonding process is, in some examples, utilized to bond different materials to each other. In one example arrangement of the rotor assembly 100 of FIG. 2, the rotor disk 110 is constructed of a lower temperature, higher ductility material relative to a rotor blade material a nickel alloy, while the rotor blade assemblies 120 are constructed of a high temperature, low ductility material, such as a gamma ti material (a titanium aluminide, such as Gamma TiAl). In an alternative aspect, the rotor blade assemblies 120 are formal from a ceramic matric composite (CMC), with the CML comprising fibers disposed within a ceramic material. In alternate examples, the rotor disk 110 or the rotor blade assemblies 120 can be constructed of different materials, such as ceramics, and achieve the same purpose.

As an alternate to the transient liquid phase bonding process, a partial transient liquid phase bonding process is utilized in some examples to connect the rotor blade assembly 120 to the rotor disk 110. In the partial transient liquid phase bonding process, the interlayer material has thin layers of low-melting point metals or alloys on each side of a thicker refractory metal or alloy layer. By way of example, the partial transient liquid phase bonding process can be used to connect the rotor disk 110 to the rotor blade assembly 120 when at least one of the rotor disk 110 and/or the rotor blade assembly 120 are constructed of a non-metallic material.

In another aspect, the rotor blade assembly 120 is fabricated in whole or in part of ceramic matrix composite material and is joined to a rotor disk 110 constructed of a nickel alloy. In still another aspect, the rotor blade assembly 120 is fabricated in whole or in part of ceramic matrix composite material and is joined to a rotor disk 110 that is more ductile than the rotor blade assembly 120. As used herein, the partial transient liquid phase bonding process, or a multi-layer transient liquid phase bonding process, is utilized as an alternative approach to bonding disparate materials where the transient liquid phase bonding process is unsuitable due to the differing diffusion characteristics of the parts to be joined, such as the different diffusion characteristics of a ceramic matrix composite material versus a nickel alloy.

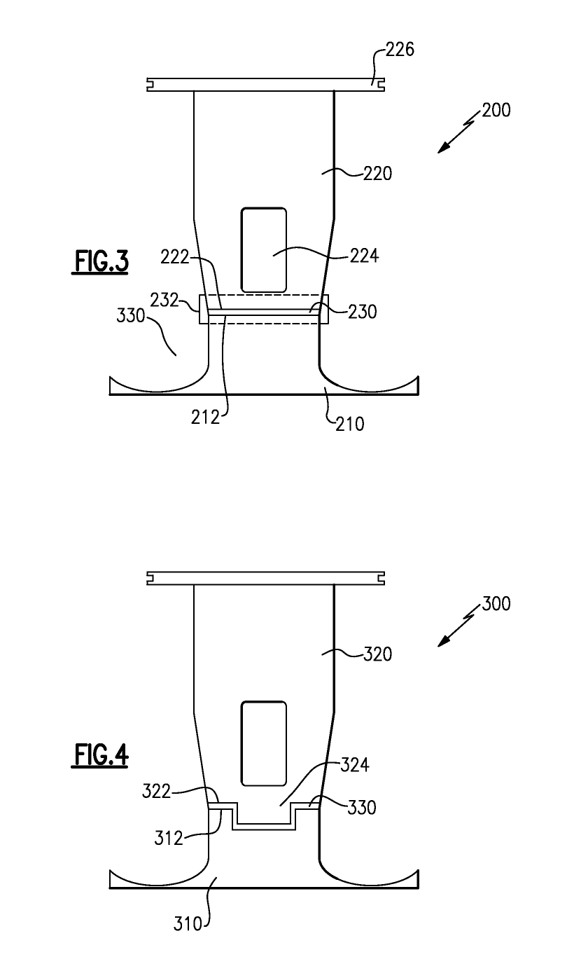

FIG. 3 schematically illustrates a partial fore view of a rotor blade 220 and rotor disk 210 connection for a rotor assembly 200. As described above, the rotor blade assembly includes a rotor blade region 220, a planar bond surface 222 in a root region 232 for connecting to the rotor disk 210, and a blade seal feature 226. The illustrated blade seal feature 226 is a feather seal slot, however any other appropriate blade sealing type can be utilized at the blade seal feature 226.

The rotor blade 220 includes an internal cooling passage with a cooling passage opening 224 that admits cooling fluid (such as air) into the internal cooling passage. The cooling passage opening 224 in the embodiment depicted is fore facing and is defined entirely by the rotor blade 220. In alternate embodiments the opening 224 can be either fore or aft facing relative to gas flowing through the gas flow path. A cover plate can be attached to the rotor assembly 200 and utilized to direct air flow to the cooling passage opening 224 in examples where cooling is necessary. In one aspect a compressor blade cooling flow passage is provided within a rotor blade configured for use in the compressor section 24 of the engine 20. The compressor cooling flow passage is adapted to provide cooling air to the compressor blade thereby lowering the temperature of the compressor blade during operation.

As with the example of FIG. 2, the rotor blade 220 is connected to the rotor disk 210 using an interlayer material 230 between a rotor disk planar bonding surface 212 and a rotor blade planar bonding surface 222. In a completed rotor assembly 200, the transient liquid phase bond connecting the rotor blade 220 to the rotor disk 210 resists axial loads applied to the rotor blade 220, eliminating the need for an axial loading cover plate to prevent the rotor blade 220 from shifting as a result of the applied axial loads. As a result, a rotor disk cover plate is only utilized when it is desirable to direct cooling air flow to the cooling passage opening 224. In such examples, the cover plate is made lighter than existing cover plates as the axial loading features of the cover plate can be removed entirely, thereby achieving weight benefits. Furthermore, in such examples, the cover placed is spaced axially from the root 232 of the rotor blade 220.

In a further example, the rotor assembly 200 is located in a low-temperature (cool) turbine engine section, or is constructed of materials with a high heat tolerance such as ceramics. As a result of being located in a cool engine section or having a higher heat tolerance, no cooling flow is needed, and the internal cooling passage and corresponding cooling passage opening 224 can be omitted from the rotor blade 220. In such an example the cover plate is also omitted entirely.

FIG. 4 schematically illustrates a partial view of another example rotor blade 320 and rotor disk 310 connection for a rotor assembly 300. The rotor disk 310 and the rotor blade 320 of FIG. 4 are identical to the rotor disk 210 and rotor blade 220 of FIG. 3 with the exception of the planar bond surfaces 322, 312 and the interlayer material 330. The planar transient liquid phase bonding surfaces 322, 312 of the example of FIG. 4 include an additional geometric feature 324. While the geometric feature 324 of FIG. 4 is illustrated as a peg shape, it is understood that alternate geometric features could similarly be used, provided the transient liquid phase bonding surfaces 312, 322 are facing surface.

While the above disclosure is directed to a turbine rotor assembly 100, 200, 300 for utilization in a turbine engine 20 for an aircraft, it is understood that the same design and process can be utilized in other applications, such as a land-based turbine, and still fall within the bounds of this disclosure.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A turbine engine comprising:
a compressor section;
a combustor in fluid communication with the compressor section;
a turbine section in fluid communication with the combustor;
a gas path defined by said compressor section, said combustor and said turbine section, wherein said gas path includes at least one rotor assembly, wherein said rotor assembly includes:
a rotor disk constructed of a first material;
a plurality of rotor blades constructed of a second material; and
a transient liquid phase bond connecting a bond surface of said rotor disk and a bond surface of each of said rotor blades.

2. The turbine engine of claim 1, wherein said transient liquid phase bond is a partial transient liquid phase bond.

3. The turbine engine of claim 2, wherein said transient liquid phase bond is a combined transient liquid phase bond and partial transient liquid phase bond.

4. The turbine engine of claim 1, wherein said transient liquid phase bond is a diffusion layer formed of material diffused from a thin foil interlayer material.

5. The turbine engine of claim 1, further comprising at least one cover plate connected to a cover plate mounting feature of said rotor disk, wherein said cover plate is spaced from a root portion of the rotor blade.

6. The turbine engine of claim 1, further comprising a compressor blade cooling flow passage disposed entirely within said rotor blade.

7. The turbine engine of claim 1, further comprising a blade cooling flow passage having a blade cooling flow passage inlet disposed on an inner diameter surface of said rotor blade, and defined entirely by said rotor blade.

8. The turbine engine of claim 1, wherein each of said rotor blades is constructed of a high temperature, low ductility first material, and wherein said rotor disk is constructed of a second material having, as compared to said first material lower temperature and higher ductility.

9. The turbine engine of claim 1, wherein each of said rotor blades is sealed on an axially outer end to at least one corresponding stator.

10. A rotor assembly for a turbine engine comprising:
a rotor disk constructed of a first material;
a plurality of rotor blades constructed of a second material; and
a diffusion material diffused into a diffusion region of said rotor disk and a diffusion region of each of said rotor blades, thereby bonding each of said rotor blades to said rotor disk.

11. The rotor assembly of claim 10, wherein said transient liquid phase bond is a partial transient liquid phase bond.

12. The rotor assembly of claim 11, wherein said transient liquid phase bond is a combined transient liquid phase bond and partial transient liquid phase bond.

13. The rotor assembly of claim 10, wherein said transient liquid phase bond is a diffusion layer formed of material diffused from a thin foil interlayer material.

14. The rotor assembly of claim 10, further comprising at least one cover plate connected to a cover plate mounting feature of said rotor disk, wherein said cover plate is spaced from a diffusion region of the rotor blade.

15. The rotor assembly of claim 10, further comprising a compressor blade cooling flow passage disposed entirely within said rotor blade.

16. The rotor assembly of claim 10, further comprising a blade cooling flow passage having including a blade cooling flow passage inlet disposed on an inner diameter surface of said rotor blade, and defined entirely by said rotor blade.

17. The rotor assembly of claim 10, wherein each of said rotor blades is constructed of a gamma ti material, and wherein said rotor disk is constructed of a nickel alloy.

18. The rotor assembly of claim 10, wherein said rotor assembly is characterized by a lack of cover plates.

19. A method for assembling a rotor assembly for a turbine engine comprising the steps of:
disposing an interlayer material between a rotor blade bond surface and a rotor disk bond surface;
heating said interlayer material such that said interlayer material diffuses into each of said rotor blade bond surface and said rotor disk bond surface, thereby creating an interlayer bond connecting said rotor blade to said rotor disk.

20. The method of claim 20, further comprising repeating the steps of disposing an interlayer material between a rotor blade bond surface and a rotor disk bond surface and heating said interlayer material such that said interlayer material diffuses into each of said rotor blade bond surface and said rotor disk bond surface, thereby creating an interlayer bond connecting said rotor blade to said rotor disk for each rotor blade connected to said rotor disk.

21. The method of claim 20, wherein said step of disposing an interlayer material between a rotor blade bond surface and a rotor disk bond surface comprises disposing an interlayer material having a single material composition between said rotor blade bond surface and a rotor disk bond surface.

22. The method of claim 20, wherein said step of disposing an interlayer material between a rotor blade bond surface and a rotor disk bond surface comprises disposing an interlayer material at least having layers of a low-melting point interlayer material on at least two sides of a refractory material layer between said rotor blade bond surface and a rotor disk bond surface.

23. The method of claim 23, wherein said step of comprises disposing an interlayer material having layers of a low-melting point interlayer material on at least two sides of a refractory material layer between said rotor blade bond surface and a rotor disk bond surface comprises contacting each of said rotor blade bond surface and said rotor disk bond surface with a single layer of said low-melting point interlayer material.

24. The method of claim 20, wherein said step of disposing an interlayer material between a rotor blade bond surface and a rotor disk bond surface comprises disposing an interlayer material comprising two distinct material layers between said rotor blade bond surface and a rotor disk bond surface.
